(19) United States
(12) Patent Application Publication
(10) Pub. No.: US 2007/0231456 A1
(43) Pub. Date: Oct. 4, 2007

(54) Combination candy pop and flavored dip

(76) Inventor: Jules R. Shecter, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 11/731,602

(22) Filed: Mar. 30, 2007

Related U.S. Application Data
(60) Provisional application No. 60/788,206, filed on Mar. 31, 2006.

(51) Int. Cl. A23G 3/00

(52) U.S. Cl. 426/660

(57) ABSTRACT

A candy food product comprises a candy pop having a confectionery product formed and supported at a top of a holder, and a container for storing a candy syrup. The container further comprises a basin having a closed bottom and sides and an open top, and a lid sealingly engagable with the open top. A retainer is mounted to an outside surface of the basin sides and is cooperatively engagable with the holder for securing the candy pop to the basin.

### BACKGROUND OF THE INVENTION

This non-provisional application is based on provisional patent application Ser. No. 60/788,206 filed on Mar. 31, 2006.

### FIELD OF THE INVENTION

The present invention relates to a novelty candy product and more particularly, to a hard candy pop that removably attaches to a canister of flavored syrup so that the candy pop can be dipped in the syrup and thus be consumed in conjunction with the flavored syrup.

### DISCUSSION OF THE RELATED ART

Lollipops and other hard candy pops have been traditionally placed on a stick to permit repeated removal and placement of the candy within one's mouth without having to touch the candy, thereby providing a convenient and sanitary means of consuming the candy product. Over the years, various hard candy pops have been produced in a multitude of shapes, sizes, and flavors. Additionally, candy pops have been formed around various supporting structures to provide additional novelty aspects to make the product more desirable.

These and other hard candy pops and holder devices provide a fun alternative to the traditional candy pop. In particular, children are attracted to candy pops that incorporate some novelty aspect in addition to the flavor of the hard candy of the pop. For this reason, many children will choose a candy pop

While various configurations of candy pops include different sizes, shapes, single flavors, multi-flavors, and holders as novelty features to increase desire for the pops, probably the most important feature is flavor. Candy pops being essentially hard candy are primarily sugar and thus sweet. However, desired flavors are more than merely the sweetness of sugar, but also include recognizable flavors such as fruits to mimic naturally tasting foods we encounter in our nutritional intake. However, there are some favored combinations that include distinct flavor layers and textures as opposed to a homogenous hard candy incorporating all flavors into the hard candy such as caramel and apples or strawberries and chocolate.

Thus what is desired is a novelty candy product that incorporates both a hard candy flavored candy pop and a compatible flavored syrup.

### SUMMARY OF THE INVENTION

One aspect of the present invention is directed to a candy food product comprising a candy pop having a confectionery product formed and supported at a top of a holder, and a container for storing a candy syrup. The container further comprises a basin having a closed bottom and sides and an open top, and a lid sealingly engagable with the open top. A retainer is mounted to an outside surface of the basin sides and is cooperatively engagable with the holder for securing the candy pop to the basin.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded perspective view of a combination candy pop and syrup container embodying the present invention;

Like reference numerals refer to like parts throughout the several views of the drawings.

### DETAILED DESCRIPTION OF THE PREFERRED EMBODIMENTS

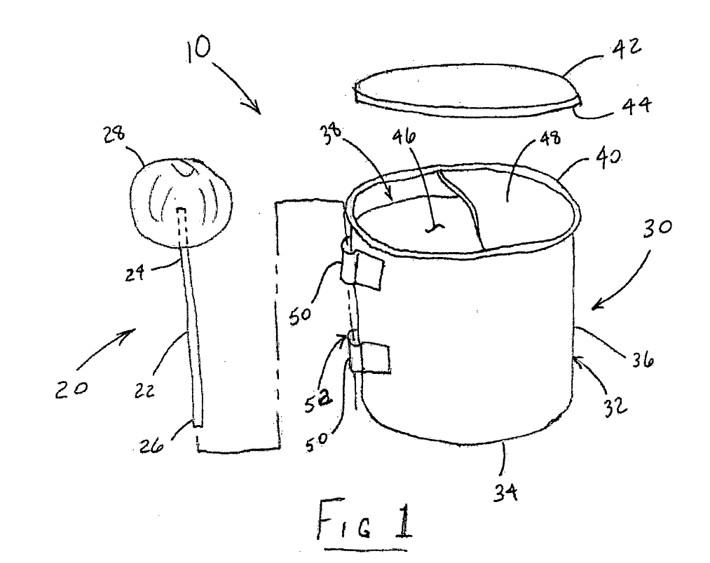

For purposes of description herein, the terms “upper”, “lower”, “left”, “rear”, “right”, “front”, “vertical”, “horizontal”, and derivatives thereof shall relate to the invention as oriented in FIG. 1. However, it is to be understood that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

Turning to the drawings, FIG. 1 shows a candy food product 10 comprising a candy pop 20 which is removably engaged with container 30 and is one of the preferred embodiments of the present invention and illustrates its various components.

Candy pop 20 has a rigid holder 22 and a confectionery product 28 such as hard candy molded about a top end 24 of holder 22. In the preferred embodiment, holder 22 is a rigid circular rod-like stick such as a wooden stick or one formed from paper fiber. Confectionery product 28 typically has a fruit flavor and is formed into a shape corresponding to the fruit represented by the flavor. As an example, confectionery product 28 when having an apple flavor would be shaped and colored as an apple. Or, alternatively, confectionery product 28 when having a strawberry flavor would be shaped and colored as a strawberry.

Container 30 comprises a basin 32 which has a closed bottom 34 and sides 36. In practice, such a basin is typically formed of a molded resin and can be circular, polygonal, or other unique cross-sectional shape. Basin 32 has an open top 38 about which is formed a rim 40. A lid 42 sized to cover open top 38 has a lip 44 which sealingly engages rim 40. When lip 44 is engaged with rim 40, contents of container 30 are retained therein regardless of the orientation of container 30. Container 30 is at least partially filled with a candy syrup 46 into which candy pop 20 can be dipped by a consumer. Candy syrup 46 is flavored to complement the flavor of candy pop 20. For example, if confectionery product 28 is apple flavored, syrup 46 could be caramel flavored, or if confectionery product 28 is strawberry flavored, syrup 46 could be chocolate flavored. The syrup 46 can also be safety sealed within basin 32 during manufacture by affixing a foil seal 48 across rim 40.

A retainer 50 is affixed to side 36 of basin 32. In the preferred embodiment, retainer 50 is bonded to side 36 and forms a loop 52 wherein loop 52 is aligned parallel to side 36 and is sized to closely receive holder 22 therein. Two retainers 50 are arranged on side 36 in a vertically spaced apart relationship to vertically support candy pop 20. Alternatively only one retainer 50 may be used provided that the vertical height of the single retainer 50 is sufficient to support candy pop 20 in a vertical orientation.

In use, a consumer of food product 10 would remove candy pop 20 by vertically extracting holder 22 from retainers 50. The consumer can then suck on the confectionery product. Additionally, the consumer can remove the lid 42 and foil 48 from basin 36 thereby exposing flavored syrup 46 and then, while grasping holder 22, dip confectionery product 28 into flavored syrup 46. In such manner, the consumer can enjoy the combined flavor of the confectionery product 28 and flavored syrup 46.

Those practiced in the art will readily recognize that alternative configurations of holder 22 and retainer 50 can be utilized to removably affix candy pop 20 to container 32. The requirement being that holder 22 and retainer 50 inter-engage one with the other to affix candy pop 20 to container 32.

In the foregoing description those skilled in the art will readily appreciate that modifications may be made to the invention without departing from the concepts disclosed herein. Such modifications are to be considered as included in the following claims, unless these claims expressly state otherwise.

We/I claim:

1. A candy food product comprising:
a candy pop having a confectionery product formed and supported at a top of a holder; and
a container, said container further comprising:
a basin for containing a candy syrup, said basin having a closed bottom and sides and an open top;
a lid sealingly engagable with said open top; and
a retainer mounted to an outside surface of said basin sides, said retainer cooperatively engagable with said holder for securing said candy pop to said basin.
